(19) United States
(12) Patent Application Publication
(10) Pub. No.: US 2015/0371644 A1
(43) Pub. Date: Dec. 24, 2015

(54) NON-LINEAR INVERSE CODING OF MULTICHANNEL SIGNALS

(71) Applicant: StormingSwiss GmbH, Morges (CH)

(72) Inventor: Clemens Par, Cinuos-chel (CH)

(73) Assignee: StormingSwiss GmbH, Morges (CH)

(21) Appl. No.: 14/441,898

(22) PCT Filed: Nov. 11, 2013
(86) PCT No.: PCT/EP2013/073526

§ 371 Date: Sep. 9, 2015

(30) Foreign Application Priority Data
Nov. 9, 2012 (CH) 2300/12

(51) Int. Cl. G10L 19/008; H04S 5/00

(52) U.S. Cl. CPC G10L 19/008; H04S 5/005; H04S 2400/01; H04S 2400/03

(57) ABSTRACT

Upmix or coding apparatus for an audio signal, having: an inverse coding apparatus for determining a first channel and a second channel by means of linear inverse coding from an input signal; characterized by a first gain (50001) connected downstream of the inverse coding apparatus in the first channel; or a first gain (60001) connected downstream of the inverse coding apparatus in the first channel and a second gain (60002), which is different from the first gain (60001), connected downstream of the inverse coding apparatus in the second channel.

The obtaining of signals of a higher order (with a higher number of output channels) from signals of a lower order (with a lower number of channels) represents an important part of audio technology. This is referred to as “upmixing”.

The efficient encoding of multi-channel signals with naturally high bandwidth for psychoacoustic encoding processes constituting the state of the art also represents a great challenge. In particular, formats such as the three-dimensional system Hamasaki 22.2 developed by the Japanese broadcaster NHK require high permanent spatial bitrates.

If such three-dimensional systems are to be embedded in existing data or if the requirements in terms of computing power of the decoding system are designed in such a way that only limited capacity is available for the decoding and the reproducing of audio data (“low computational complexity systems”), psychoacoustic encoding processes constituting the state of the art fail.

The patent applications and publications regarding psychoacoustic and in particular spatial encoding processes are countless. An extensive account must therefore be eschewed. Permanent spatial bitrates that need to be transmitted to a decoder in order to be able to extract corresponding multi-channel signals represent however a common feature.

The present invention provides audio encoding with enhanced possibilities for defining spatial audio signals on the basis of only a few parameters which, in contrast to known psychoacoustic and in particular spatial encoding processes—do not need to be continuously added to the data stream.

The system works in particular independently of the choice of a suitable codec for compressing audio data (“base audio coder”). Such codecs describe for example standards that are currently valid or in development, that have become known as MP3, AAC, HE-AAC or USAC.

Hereinafter, “inverse coding” is understood to mean a technical process that makes use of one or several methods or one or several devices of the claims of applications EP1850629 or WO2009138205 or WO2011009649 or WO2011009650 or WO2012016992 or WO2012032178. The documents just mentioned are hereby introduced as reference.

In particular, “inverse coding” describes a technical process that generates spatial audio signals through the specific application of gains and delays that are functionally interdependent.

The systems described in EP1850629 or WO2009138205 or WO2011009649 or WO2011009650 or WO2012016992 or WO2012032178 are in particular based on the principle of homogeneous energy density for the valid generation of phantom sources. In particular, spatial audio signals are generated in EP1850629 or WO2009138205 or WO2011009649 or WO2011009650 or WO2012016992 or WO2012032178, whose individual channels don't have different modulation. Such a homogeneous modulation is necessary in order to achieve a uniform mapping of the phantom sources. This applies, as shown for example in FIG. 6F, FIG. 7F and FIG. 8F of WO2012032178 for a 5.1 surround signal, also for the inverse coding of multi-channel signals.

So-called downmix processes are known for example from ITU-R BS.775-1 (see FIG. 21). In this case, it is an addition schema for the reduction of the number of channels, wherein the level of specific channels is partly reduced, for example by −3 dB (which corresponds to a multiplication of the signal level by a factor of 1/\sqrt{2} or, rounded, 0.7071) resp. −6 dB (which corresponds to a multiplication of the signal level by a factor of 0.5000).

Such addition schemas can have other levels for specific channels that can be determined resp. optimized in functional dependency of a signal analysis, such as the state-of-the-art Karhunen-Loéve transformation (KLT) or Principal Component Analysis (PCA) or by means of algebraic invariants according to EP1850629, WO2009138205, WO2011009649, WO2011009650, WO2012016992 and WO2012032178, or they can be enriched by further specific technical means:

Faller and Schillebeeckx for example proposed at the 130^{th} AES Convention in London in P4-5 (“Improved ITU and Matrix Surround Downmixing”) the use of 90° filters known in the state of the art.

Overall, such downmix processes constitute the basis for the reproduction of signals with a higher number of audio channels (“higher order signals”) on reproduction systems with a lower number of audio channels (“lower order signals”) and provide furthermore the precondition for the reduction of the bandwidth of audio signals, such as are known from the audio coding for example for standards such as MPEG Surround.

Such downmix processes can be adaptive, in that the levels of specific channels change over the course of time (“adaptive downmix”) or the same levels of specific channels remain constant over the course of time and are therefore non-adaptive (“automatic downmix”).

Such downmix processes can in particular be optimized for a direct acoustic reproduction of the downmix or these downmix processes are purely intended for a reduction of the bandwidth of audio signals.

Loudspeaker configurations are known in the literature that, in contrast to the surround configurations such as 5.1 or 7.1 customarily available on the market and in which the loudspeakers are located in one plane, provide also loudspeakers outside of this plane. These partly represent own standards, such as for example the three-dimensional system Hamasaki 22.2 developed by the Japanese broadcaster NHK, from which most of the multi-channel processes known today can be derived. These are overall highly complex systems in which the formation of countless phantom sources can be observed between respective neighboring loudspeakers.

Overall, the inverse coding of surround signals such as 5.1 or 7.1 or also of three-dimensional systems unavoidably results in loudspeaker signals that as a rule have a homogeneous modulation and thus an unnaturally high energy density. However, according to the state of the art, such an energy density is necessary in order to make possible the formation of corresponding phantom sources. Hereinafter, we therefore call such a process “linear inverse coding”.

In particular, WO2011009649 describes a system where two panoramic potentiometers are connected downstream of an MS matrix within a device or a process for linear inverse coding, wherein each of the panoramic potentiometers forms two collective busbar signals. Such a configuration allows the degree of correlation to be increased or decreased at will and results in an increase or decrease of the image widths to the stereo base between two loudspeakers. However, the first output signal of the MS matrix, inasmuch as the first panoramic potentiometer is effective, is provided in a previously determined ratio to the two channels of the first collective busbar signal. Similarly, the second output signal of the MS matrix, if the second panoramic potentiometer is effective, is provided in a previously determined ratio to the two channels of the second collective busbar signal.

### DISCLOSURE OF THE INVENTION

According to the invention, however, it was observed surprisingly and against previous experience that although it is possible on the one hand to choose an input signal for a linear inverse coding from audio signals or from signals derived from a downmix generated from any technical means, in order to generate additional channels, and thus a higher order signal as compared to the base signal or the downmix (“upmixing” or “encoding”), it is also possible on the other hand to reproduce the audio channels generated through linear inverse coding with different levels, wherein these levels can be derived fully or partly from the levels of the used audio signals or the levels used during the downmixing, or also determined fully or partly independently from them. Alternatively, inverse coding can occur already on the basis of the differently modulated output channels. In both cases, whenever such a technical step takes place, we speak of “non-linear inverse coding”.

The non-linear inverse coding therefore has no homogeneous energy density with slightly modified phantom source formation and thus contradicts the ostensible postulate of a stereo base that should be as homogeneous as possible between neighboring loudspeakers to generate phantom sources.

However, this non-homogeneous energy density contributes to a natural aural impression that draws increasingly closer to transparency as the number of input channels increases. When the number of input channels increases, the human ear judges transparency less in terms of the absolute position of the phantom sources but rather in relation to the energy density of the generated sound field. The present invention thus takes advantage of this principle in a targeted manner.

In particular, when the number of reproduction channels increases, the immediate psychoacoustic localization of the loudspeakers, i.e. nearly point-shaped sound sources, predominates over the perception of phantom sources between the loudspeakers. The non-linear inverse coding thus ensures that also in this case, a correct distribution resp. weighting of these point-shaped sound sources as well as the phantom sources formed between the loudspeakers takes place.

Furthermore, despite using a downmix process, it is possible to achieve the perception of the tonal depth of phantom sources that in the case of signals based on phantom sources depends essentially on the loudness of a loudspeaker signal as well as on the perceived spatiality. This perceived spatiality can be controlled immediately by means of inverse coding, without additional technical means such as for example an artificial reverb being necessary.

In particular it is possible, by the appropriate choice of the levels of the output signals of an inverse coding, to achieve a non-linear inverse coding of the perceived spatiality, when a virtualization of the reproduction channels takes place via headphones by means of “head related transfer functions” (HRTF) or “binaural room impulse responses” (BRIR), which sometimes can be afflicted with essential spatial perception losses.

The level of the output signals of an inverse coding can vary as a function of time, for example in the case of an adaptive downmix process, or also remain constant over the course of time, for example in the case of a non-adaptive downmix process. The converse cases, i.e. the non-variation of the levels of the output signals of an inverse coding in the case of an adaptive downmix process or the varying of the levels of the output signals of an inverse coding in the case of a non-adaptive downmix process, are also possible in principle in these examples, in order to enable a formation as correct as possible of the perceived point-shaped sound sources as well as of the formed phantom sources between the loudspeakers.

In particular, the object of the invention as compared with WO2011009649 does not describe a system in which, inasmuch as the levels are adjusted via an amplification factor different from 1, respectively two collective busbars signals are inevitably formed. Rather, these amplification factors operate exclusively on the very channel onto which they are applied. The technical effect is thus not the arbitrary increase or decrease of the degree of correlation of two equally weighted channels. Additionally, in the case of the non-linear inverse coding, provided an amplification factor of the final level correction of at least one signal converges towards 0, in contrast to WO2011009649, the audio information of this signals is unavoidably lost, and it is thus no longer a case of the loss-free increase or decrease of the image width to the stereo base between two loudspeakers but a case, appropriate in its simplicity, of the targeted homogeneous weighting of perceived point-shaped sound sources (loudspeakers) as well as of the phantom sources formed between these loudspeakers.

Rather, the two panoramic potentiometers that in WO2011009649 were connected downstream of an MS matrix, with each panoramic potentiometer forming two collective busbar signals, to be considered part of a linear inverse coding, on whose output signals in at least one case additionally an amplification factor according to the non-linear inverse coding can be applied—and thus overall a form of weighting is achieved that is not possible on the basis of these two panoramic potentiometers alone.

One embodiment shows a device/a process for the non-linear inverse coding of an audio signal, characterized in that either: a gain is connected downstream of one of the two output signals; or: respectively one gain is each connected downstream of one of the two output signals, wherein these two gains are different.

One embodiment shows a device/a process for the non-linear inverse coding of an audio signal, characterized in that either: a gain is connected downstream of one of the two output signals; or: respectively one gain is each connected downstream of one of the two output signals, wherein these two gains are different.

One embodiment shows a device/a process for the non-linear inverse coding of an audio signal, characterized in that either: a gain (50001) has the factor 0.5 or the factor 1/\sqrt{2}; or: at least one of the two gains (60001, 60002) has the factor 0.5 or the factor 1/\sqrt{2}.

One embodiment shows a device/a process for the non-linear inverse coding of an audio signal, characterized in that the non-linear inverse coding occurs on the basis of signals of a downmix.

One embodiment shows a device/a process for the non-linear inverse coding of an audio signal, characterized in that the downmix is formed on the basis of one gain or several gains that have the factor 0.5 or the factor 1/\sqrt{2}.

One embodiment shows a device/a process for the non-linear inverse coding of an audio signal, characterized in that the downmix in addition to means for forming sum signals, is formed on the basis of further technical means.

One embodiment shows a device/a process for the non-linear inverse coding of an audio signal, characterized in that means for the immediate reproduction of the downmix is used on loudspeakers.

One embodiment shows a device/a process for the non-linear inverse coding of an audio signal, characterized in that means for obtaining further signals from previously available or formed signals are used.

One embodiment shows a device/a process for the non-linear inverse coding of an audio signal, characterized in that means for adding up signals are used.

One embodiment shows a device/a process for the non-linear inverse coding of an audio signal, characterized in that means for subtracting signals are used.

One embodiment shows a device/a process for the non-linear inverse coding of an audio signal, characterized in that means for comparing correlations of signals are used.

One embodiment shows a device/a process for the non-linear inverse coding of an audio signal, characterized in that means for normalizing signals on the basis of the levels of previously available or formed signals are used.

One embodiment shows a device/a process for the non-linear inverse coding of an audio signal, characterized in that means for adding up signals respectively with non-neighboring loudspeaker channels are used.

One embodiment shows a device/a process for the non-linear inverse coding of an audio signal, characterized in that means for forming a fictitious loudspeaker are used.

One embodiment shows a device/a process for the non-linear inverse coding of an audio signal, characterized in that means for coding the downmix by means of a base audio coder are used.

One embodiment shows a device/a process for the non-linear inverse coding of an audio signal, characterized in that means for forming signals for a loudspeaker configuration of the type Hamasaki 22.2 or for a subgroup of such a loudspeaker configuration are used.

One embodiment shows a device/a process for the non-linear inverse coding of an audio signal, characterized in that means for determining the position of phantom sources are used.

One embodiment shows a device/a process for the non-linear inverse coding of an audio signal, characterized in that means for signal analysis or means for determining algebraic invariants are used.

One embodiment shows a device/a process for the non-linear inverse coding of an audio signal, characterized in that means for a Karhunen-Loéve transformation (KLT) or Principal Component Analysis (PCA) are used.

One embodiment shows a device/a process for the non-linear inverse coding of an audio signal, characterized in that means for optimizing the determination of algebraic invariants on the basis of a Karhunen-Loéve transformation (KLT) or Principal Component Analysis (PCA) are used.

One embodiment shows a device/a process for the non-linear inverse coding of an audio signal, characterized in that either: a gain of the non-linear inverse coding has the same factor of a gain used for the downmix or represents a multiple of this gain; or: at least one of the two gains (60001, 60002) of the non-linear inverse coding has the same factor of a gain used for the downmix or represents a multiple of this gain.

One embodiment shows a device/a process for the non-linear inverse coding of an audio signal, characterized in that for optimizing one or several parameters of the non-linear inverse coding, means for optimizing on the basis of the associated linear inverse coding are used.

One embodiment shows a device/a process for the non-linear inverse coding of an audio signal, characterized in that means for immediately optimizing one or several parameters of the non-linear inverse coding are used.

One embodiment shows a device/a process for the non-linear inverse coding of an audio signal, characterized in that means for optimizing one or several parameters of the non-linear or associated linear inverse coding on the basis of the degree of correlation r are used.

One embodiment shows a device/a process for the non-linear inverse coding of an audio signal, characterized in that means for optimizing one or several parameters of the non-linear or associated linear inverse coding on the basis of a target correlation k are used.

One embodiment shows a device/a process for the non-linear inverse coding of an audio signal, characterized in that means for determining the nature of the signal are used.

One embodiment shows a device/a process for the non-linear inverse coding of an audio signal, characterized in that means for determining language or vocal signals or transients are used.

One embodiment shows a device/a process for the non-linear inverse coding of an audio signal, characterized in that means for determining the target correlation k on the basis of the nature of the signal are used.

One embodiment shows a device/a process for the non-linear inverse coding of an audio signal, characterized in that means are used, in the case of a non-linear inverse coding, in order to either: in the case of voice or vocal recordings, to establish a target correlation k≧+0.51; or: in the case of transients, to establish a target correlation k≧+0.25; or: in the case of other signals, to establish a target correlation k≧0.00.

One embodiment shows a device/a process for the non-linear inverse coding of an audio signal, characterized in that means are used, in the case of a linear inverse coding associated to a non-linear inverse coding, in order to either: in the case of voice or vocal recordings, to establish a target correlation k≧+0.66; or: in the case of transients, to establish a target correlation k≧+0.40; or: in the case of other signals, to establish a target correlation k≧0.00.

One embodiment shows a device/a process for the non-linear inverse coding of an audio signal, characterized in that for a non-linear or associated linear inverse coding, means for their optimization are used, which in turn use a signal section smaller than or equal to 40 ms.

One embodiment shows a device/a process for the non-linear inverse coding of an audio signal, characterized in that for a non-linear or associated linear inverse coding, means for their optimization are used that in turn use means for weighting the virtual opening angles α resp. β.

One embodiment shows a device/a process for the non-linear inverse coding of an audio signal, characterized in that means for optimizing one or several parameters of a non-linear or associated linear inverse coding on the basis of the main reflections or the reverb diffusion are used.

One embodiment shows a device/a process for the non-linear inverse coding of an audio signal, characterized in that means for correcting the level of signals on the basis of the respective loudspeaker positions are used.

One embodiment shows a device/a process for the non-linear inverse coding of an audio signal, characterized in that a panoramic potentiometer is used.

One embodiment shows a device/a process for the non-linear inverse coding of an audio signal, characterized in that means for varying the gain (717) with the factor λ are used.

One embodiment shows a device/a process for the non-linear inverse coding of an audio signal, characterized in that different loudspeaker distances are compensated by at least one gain and at least one delay.

One embodiment shows a device/a process for the non-linear inverse coding of an audio signal, characterized in that means for storing or transmitting one or several parameters of a non-linear or associated linear inverse coding are used.

One embodiment shows a device/a process for the non-linear inverse coding of an audio signal, characterized in that these have fewer output channels compared with a multi-channel signal.

One embodiment shows a device/a process for the non-linear inverse coding of an audio signal, characterized in that these have more output channels compared with an audio signal.

One embodiment shows a device/a process for the non-linear inverse coding of an audio signal, characterized in that the signal reproduction does not take place on the basis of a loudspeaker configuration corresponding to the format of the respective signal.

One embodiment shows a device/a process for the non-linear inverse coding of an audio signal, characterized in that either: means for wave field synthesis are used; or: means for Head Related Transfer Functions (HRTF) or Binaural Room Impulse Responses (BRIR) are used.

### DESCRIPTION OF THE DRAWINGS

Different embodiments of the present invention will be described hereafter by way of example, with reference being made to the following drawings:

FIG. 1 shows the loudspeaker configuration of the format Hamasaki 22.2 from the Japanese broadcaster NHK.

FIG. 2 shows the example of a downmix matrix for the format Hamasaki 22.2.

FIG. 3 shows a loudspeaker configuration for a 12.1 signal, representing a subset of the loudspeaker configuration for Hamasaki 22.2.

FIG. 4 shows the example of a downmix matrix for a 12.1 signal. This in turn represents a subset of the loudspeaker signals for Hamasaki 22.2.

FIG. 5 shows the example of a circuit for the non-linear inverse coding of an audio signal.

FIG. 6 shows a further example of a circuit for the non-linear inverse coding of an audio signal, wherein l₁≠l₂.

FIG. 7 represents a matrix for extracting signals by means of comparative correlations on the basis of the downmix represented in FIG. 2.

FIG. 8 shows a further example (following upon FIG. 7) of the extraction of a signal by means of comparative correlations.

FIG. 9 shows a normalization of signals (following upon FIG. 8) on the basis of known levels of the original multi-channel signal.

FIG. 10 shows an approximate recovery of signals (following upon FIG. 9) on the basis of the subtraction of obtained neighboring signals, whose level was previously corrected by −3 dB.

FIG. 11 shows the matrix (following upon FIG. 10) of two non-linear inverse codings.

FIG. 12 shows the final normalization (following upon FIG. 11) of the signals obtained on the basis of two non-linear inverse codings.

FIG. 13 shows the attenuation characteristics of a panoramic potentiometer that belongs to the state of the art. In multi-channel coding, these attenuation characteristics can also be used as basis for the calculation of level corrections.

FIG. 14 shows the second example of a matrix for extracting signals by means of comparative correlations on the basis of the downmix represented in FIG. 4.

FIG. 15 shows a normalization of signals obtained (in FIG. 14) on the basis of known levels of sum signals.

FIG. 16 shows an approximate recovery of signals (following upon FIG. 15) on the basis of the subtraction of approximately obtained sum signals, whose level was previously corrected by −3 dB.

FIG. 17 shows the matrix (following upon FIG. 16) of two non-linear inverse codings.

FIG. 18 shows the final normalization (following upon FIG. 17) of respectively two signals obtained on the basis of two non-linear inverse codings.

FIG. 19 shows the block schema of a circuit for optimizing linear or non-linear inverse codings.

FIG. 20 shows by way of example the header information as well as the downmix for a 12.1 signal compressed on the basis of a non-linear inverse coding.

FIG. 21 shows the downmix matrix for the downmix of 3/2 source material according to ITU-R BS.775-1, table 2.

### DETAILED DESCRIPTION

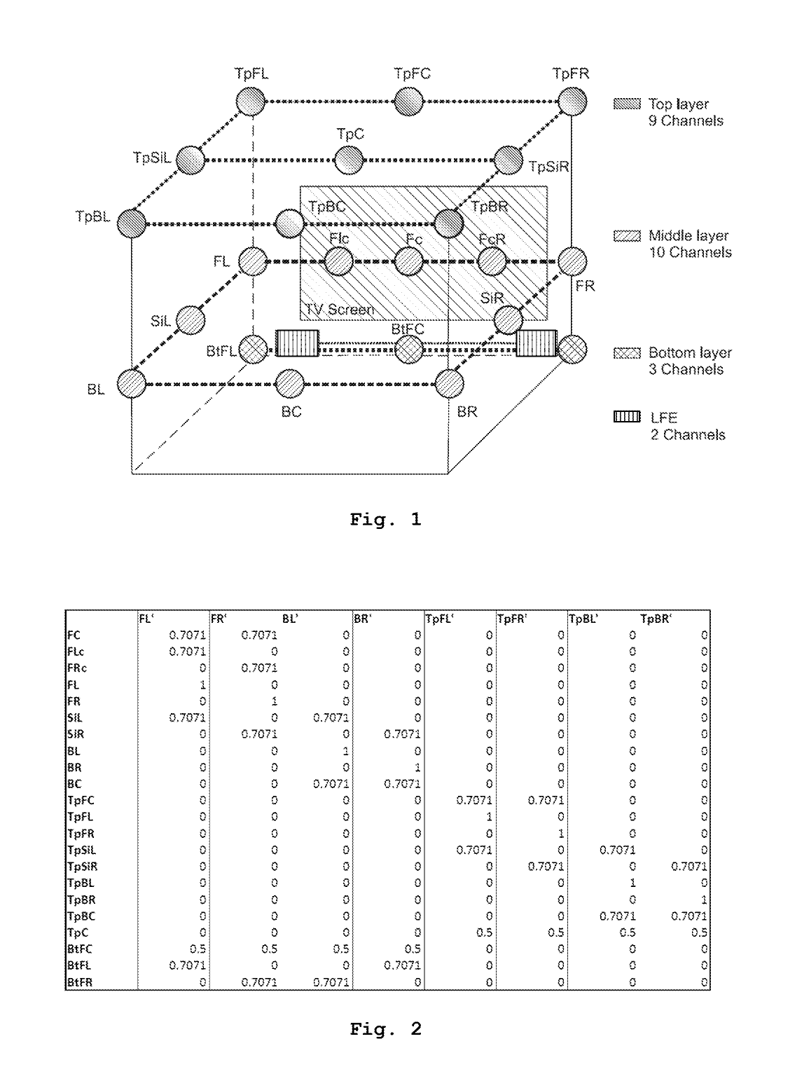

Hereafter, a configuration corresponding to Hamasaki 22.2 or a subset of this configuration will be examined (see FIG. 1). This configuration is to be understood by way of example, since the object of the invention is applicable to any multi-channel system with three or more loudspeakers in any position.

In a first step, a downmix matrix is defined that can contain the most varied technical means (such as for example those described by Faller and Schillebeeckx, see above) and that can be determined resp. optimized in functional dependency of a signal analysis of the respective multi-channel signal, such as for example the state-of-the-art Karhunen-Loéve transformation (KLT) or Principal Component Analysis (PCA) or by means of algebraic invariants according to EP1850629, WO2009138205, WO2011009649, WO2011009650, WO2012016992 and WO2012032178 (we speak hereinafter of “adaptive downmix”) or specified a priori (for example in analogous manner to table 2 of ITU-R BS.775-1, see FIG. 21) (we speak hereinafter of an “automatic downmix”).

A technical combination containing both elements of an adaptive as well as elements of an automatic downmix is also possible.

In view of the myriad of possible adaptive or automatic downmix matrices as well as of technical combinations of elements of an adaptive downmix and elements of an automatic downmix (for Hamasaki 22.2-when homogeneous signal levels are considered fairly theoretically—for n downmix channels for example this would already amount to

$$\frac{22 !}{( 22 - n ) !} ,$$

wherein—when additionally considering different levels for the summed signals—this would result in already infinite possibilities), FIG. 2 will have to be limited to the example of a downmix for Hamasaki 22.2, consisting in total of four stereo signals with the following loudspeaker configuration (see FIG. 1): FL′-FR′, BL′-BR′, TpFL′-TpFR′, TpBL′-TpBR′.

The matrix portrayed is to be read in the same way as the matrix known from the state of the art of FIG. 21 but with the lines to be read as columns and vice versa the columns as lines.

In particular in the present example TpC with a level decreased by −6 dB (which corresponds to a multiplication of the signal level by a factor of 0.5) is added respectively to TpFL′, TpFR′, TpBL′ and TpBR′, which, when reproducing the downmix, leads to the psychoacoustic phenomenon of the localization of such a loudspeaker TpC (hence called “fictitious TpC” in what follows); the same operating principle can be applied to other loudspeakers, in part by using different level differences (hereinafter therefore called “fictitious loudspeaker”, see also hereafter).

For an extraction by means of comparative correlation, which will be mentioned several times in what follows, the short-term cross correlation

$$r = \frac{1}{2 T} * {\int }_{- T}^{T} x ( t ) y ( t ) d t * \frac{1}{{x ( t )}_{eff} {y ( t )}_{eff}}$$

are considered for the interval [−T,T] as well as the signals x(t), y(t), and only those correlated signal parts of x(t) and y(t) are extracted for which r=+1.

Since only neighboring loudspeakers generate phantom sources, it is possible to extract from BtFL, BtFC and BtFR by way of comparative correlation for example approximately BtFL*, BtFC* and BtFR*:

For this purpose, first BtFC is added to BtFL′ respectively BtFR′ with a level reduced by −3 dB. BtFL′ is then added to FL′ respectively BR′ with a level reduced by −3 dB, and BtFR′ is then added to FR′ respectively BL′ with a level reduced by −3 dB. BtFL then represents approximately the correlated part of FL′ and BR′, BtFR approximately the correlated part of FR′ and BL′ and BtFC approximately the correlated part of the two last mentioned correlated parts.

In such a process, only those correlated parts that were included in FL, BR as well as FR and BL prior to our downmix and would thus be extracted at the same time and exclusively displaced onto BtFL*, BtFR* as well as BtFC* represent a problem.

The same also applies incidentally for each signal extracted by means of comparative correlation, which results in the basic problem of the fundamental impossibility of an absolute reconstruction of a higher-order signal from a lower-order signal exclusively by means of comparative correlation. Here, the non-linear inverse coding could open up completely new perspectives.

The problem can be mitigated if for example the absolute levels of the signals previously available or obtained stepwise are known and thus, since the degree of correlation for the relevant signal parts in each case amounts to +1, it is possible to draw conclusions as to the respective level of the correlated signal parts in all channels in question:

Thus, for example, the correlated signal part with the absolute level p₁ of BtFL, which was added respectively to FL′ (with known absolute level p₂) and BR′ (with known absolute level p₃) with the absolute level p₁−3 dB, enables its approximate extraction by means of comparative correlation, wherein henceforth the resulting signal BtFL* has the absolute level p₁ and its subtraction with the absolute level p₁−3 dB of FL′ with the absolute level p₂ resp. its subtraction with the absolute level p₁−3 dB of BR′ with the absolute level p₃ receives the original correlated signal parts in the resulting channels—however, only approximately.

Similarly, for example, the correlated signal part with the absolute level p₄ of BtFR, which was added respectively to FR′ (with known absolute level p₅) and BL′ (with known absolute level p₆) with the absolute level p₄−3 dB, enables its approximate extraction by means of comparative correlation, wherein henceforth the resulting signal BtFR* has the absolute level p₄ and its subtraction with the absolute level p₄−3 dB of FR′ with the absolute level p₅ resp. its subtraction with the absolute level p₄−3 dB of BL′ with the absolute level p₆ receives the original correlated signal parts in the resulting channels—however, only approximately.

BtFC* is subsequently extracted using the comparative correlation of BtFL* and BtFR*.

A downmix matrix can in particular take into account the fact that the achieved downmix can be reproduced immediately as a signal of lower order on a specific loudspeaker configuration:

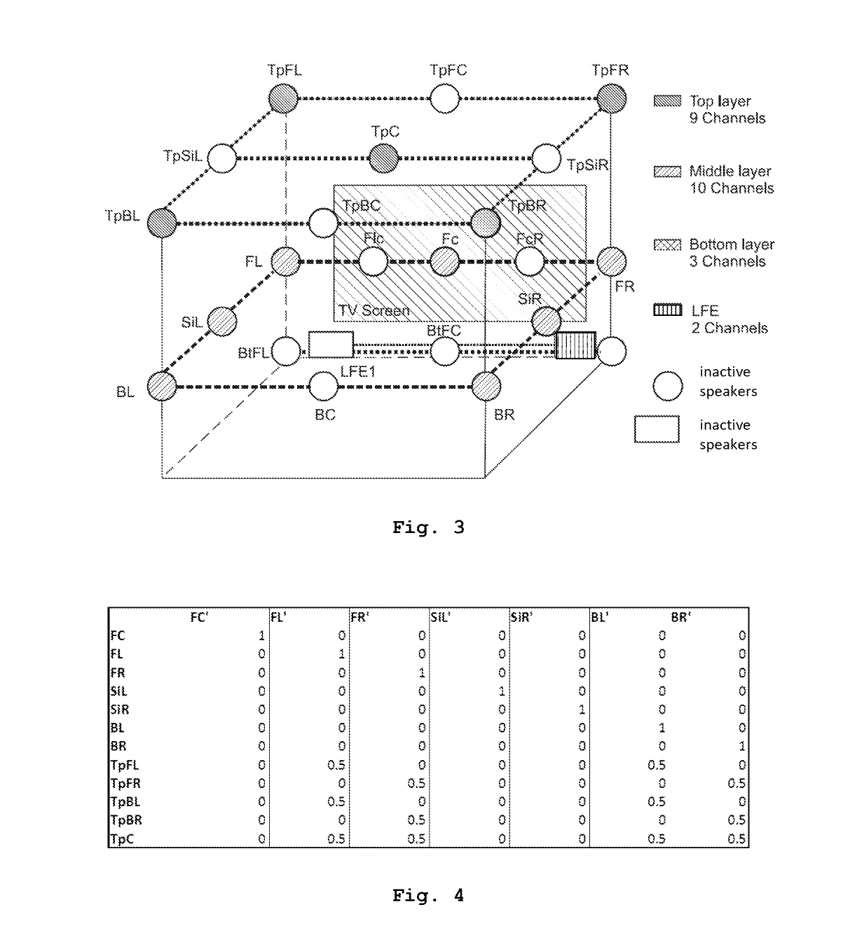

If for example a 12.1 signal is considered, that represents a subset of the loudspeakers for Hamasaki 22.2 (FL, FC, FR, LFE2, SiL, SiR, BL, BR, TpFL, TpFR, TpBL, TpBR, TpC; see FIG. 3), and its downmix is supposed to be a 7.1 surround signal, a fictitious TpC can be defined in a similar way as in the example above.

In particular, TpFL and TpBL with their respective levels reduced each by −3 dB are added together and the resulting sum is added to FL′ and BL′ respectively, with a level reduced by −3 dB. In a similar fashion, TpFR and TpBR with a level respectively reduced by −3 dB are added together and the resulting sum is added to FR′ and BR′ respectively, with a level reduced by −3 dB.

The associated downmix matrix can be seen in FIG. 4.

Although for surround 7.1 henceforth the correlated parts of FL and BL resp. of FR and BR usually end up on SiL resp. SiR, in the case of the present downmix matrix the sum of two loudspeakers each of the Top Layer then rests on FL′ and BL′ resp. FR′ and BR′ of the Middle Layer, which in an optimized manner takes into account in particular the psychoacoustic fact that the loudspeakers of the Top Layer advantageously reproduce indirect sound, and the resulting downmix is then displaced onto the loudspeakers preferably suitable therefor—and can thus as advantageously be immediately reproduced on a 7.1 surround system.

On the other hand, the sum of TpFL, TpBL and TpC resp. the sum of TpFR, TpBR and TpC can easily be extracted approximately with the above-described comparative correlation of FL′ and BL′ resp. FR′ resp. BR′. This is of crucial importance for the respective inverse coding of these sums (see below) and thus for the approximate reconstruction of the signals for TpFL* and TpBL* resp. TpFR* and TpBR*.

Both represented downmix matrices represent concrete examples, that follow ITU-R BS.775-1; however, other level corrections than −3 dB and −6 dB are, as can be readily understood, easily possible and in the concrete case desirable.

Level corrections modified in this way can occur for example when asymmetrical angles—in the case of multimedia applications for example because of taking into account an optimum stereo basis for FLc, FRc in the case of an increased screen—occur for the respective loudspeaker configuration, or an adaptive downmix (see above) or also a technical combination that comprises both elements of an adaptive as well as elements of an automatic downmix is applied.

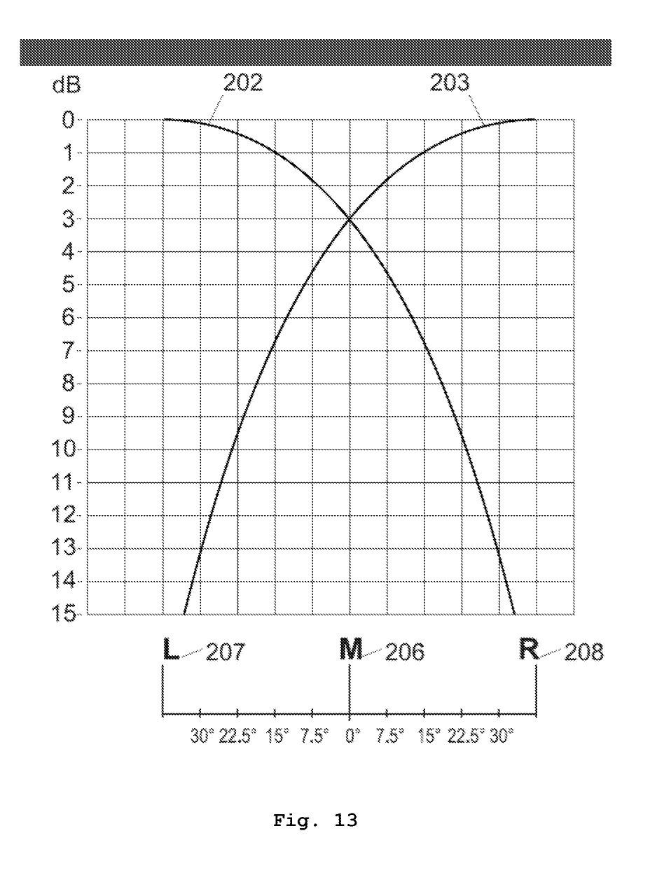

Dickreiter (Michael Dickreiter: Handbuch der Tonstudiotechnik [Handbook of Sound Engineering], vol. I.-Saur: Munich 1987) shows on page 375 the attenuation characteristic of a panoramic potentiometer from the state of the art (see FIG. 13). This attenuation characteristic can also be used as basis for the calculation of the above-mentioned, modified level corrections.

Although for example with an angle of 30° between FC and FLc, wherein the angle between FL and FC is 60°, FLc is added to both FC as well as to FL with each time −3 dB (position 0°), for example in the case of an increased angle of 45° between FC and FLc, wherein the angle between FL and FC is again 60°, FLc is now added to FC with −7 dB and to FL with −1 dB (position 15°=45°−30°).

In the case of the exclusive reproduction of the signals FC′ and FL′ thus obtained, the phantom source of a virtual FLc is formed. Simultaneously, by using extraction by means of comparative correlation with known level corrections of signals previously available or obtained stepwise, it is possible again to easily calculate approximately FLc and again to produce approximately FC as well as FL prior to the respective mixing of FLc. This principle can be extended in a generalized fashion to any number of neighboring loudspeakers (see also the explanations above re: “virtual loudspeaker”). It furthermore enables loudspeaker positions to be subsequently modified (“Flexible Rendering”).

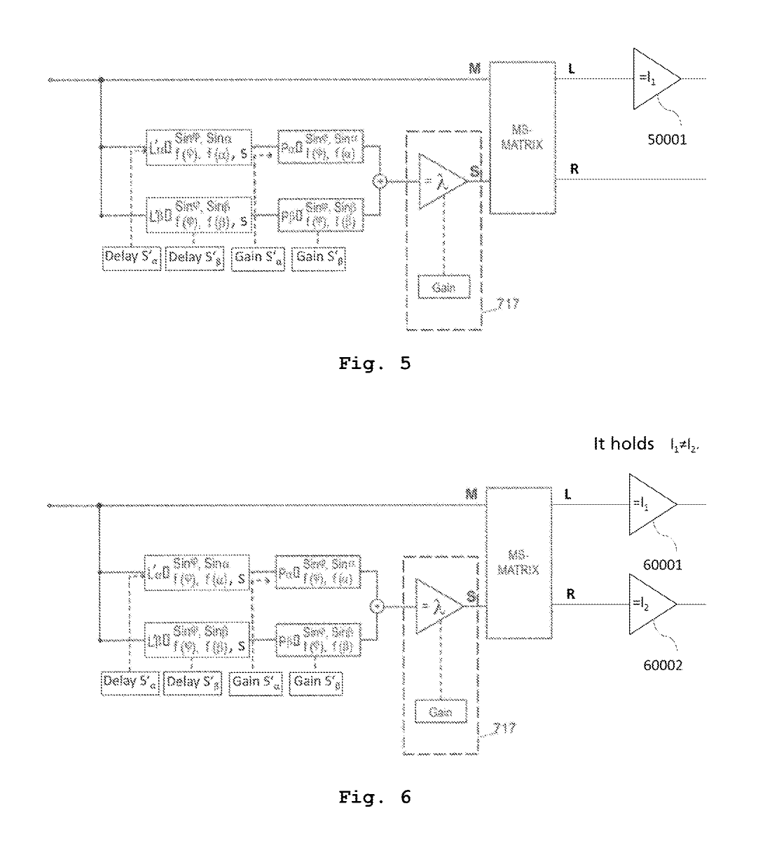

Using inverse coding incidentally also allows such a flexible rendering; in this case, for example the gain 717 of FIG. 5 resp. 6 for an increased loudspeaker distance is increased proportionally resp. for a decreased loudspeaker distance is decreased proportionally.

Different loudspeaker distances can furthermore be compensated through corresponding gains and delays, so that it can easily be seen that signals for any configurations of at least three loudspeakers can be derived from any given signal of any order, in accordance with the following principles:
summing of signals,
use of level corrections for respective summed signals,
extraction of signals by means of comparative correlation,
use of level corrections for signals previously available or obtained stepwise,
normalizing of obtained signals on the basis of known levels of signals previously available or obtained stepwise,
obtaining further signals on the basis of the respective subtraction of signals previously available or obtained stepwise, each with or without level corrections,
obtaining signals on the basis of inverse coding,
adaptation of the level of further channels to the level of signals previously available or obtained stepwise,
if applicable, correction of different loudspeaker distances by means of gains and delays,
obtaining further signals from signals previously available or obtained stepwise.

Non-Linear Inverse Coding

A further characteristic of non-linear inverse coding is based on the observation of the unexpected fact, which contradicts previous experience, that on the one hand, it is possible to subject a downmix generated with any technical means to a linear inverse coding in order to generate a higher-order signal as compared with the downmix, on the other hand to reproduce in different levels the audio channels generated through linear inverse coding, wherein these levels can be derived fully or partly from the levels used for the automatic or adaptive downmix or can also be determined fully or partly independently from the latter. Alternatively to this, the optimization of the non-linear coding of a downmix generated with any technical means can take place already on the basis of their differently modulated output channels.

In both cases, it is again possible on the basis of an automatic or adaptive downmix or also of a technical combination that contains both elements of an adaptive as well as elements of an automatic downmix to calculate signals of a higher order, which on the one hand enables higher-order signals to be embedded efficiently in lower-order signals (which can ideally be reproduced immediately as downmix), or—inasmuch as the requirements of the decoding system's computing power are designed so that only little computing capacity is available for decoding and reproducing audio data—high-quality multi-channel signals can nevertheless be reproduced.

Such a reproduction can take place via a loudspeaker configuration corresponding to the reproduction format of the resulting multi-channel signal, via a loudspeaker configuration simulating such a reproduction format (for example by means of state-of-the-art wave field synthesis based on the principle of Huygens) or also via headphones or loudspeakers, so that in this case the loudspeaker positions are simulated by means of the Head Related Transfer Functions (HRTF) or Binaural Room Impulse Responses (BRIR) known in the prior art.

The example of an inventive basic circuit for non-linear inverse coding is represented in FIG. 5 which is characterized through the downstream connecting of at least one gain (50001) in the left or right output channel. FIG. 6 on the other hand shows the downstream connection of two different gains (60001, 60002) that have proven particularly advantageous for the non-linear inverse coding of complex multi-channel signals. For the basic mode of operation of both circuits, with the exception of the above-mentioned gains (50001, 60001, 60002) represented in FIG. 5 and FIG. 6, reference is made to EP1850629, WO2009138205, WO2011009649, WO2011009650, WO2012016992 and WO2012032178.

For the sake of simplicity, we will use hereinafter for each output channel of a non-linear inverse coding according FIG. 5 resp. FIG. 6 the designation Iᵢ(lⱼ), wherein it is written in the case of missing gain with the factor lⱼ in the respective output channel Iᵢ(1).

Similarly, we use “k=+1” to indicate those channels on the basis of which an extraction occurs by means of comparative correlation. If the result is subsequently normalized on the basis of known levels of signals previously available or obtained stepwise, we call this process “absl”. If a channel is equalized to such a normalized signal in such a way that on the one hand its level characteristics are to remain the same and on the other hand if the gain lⱼ, of Iᵢ(lⱼ) in relation to the current level of this channel is to be effective for it, we write Iⱼ(lⱼ)*.

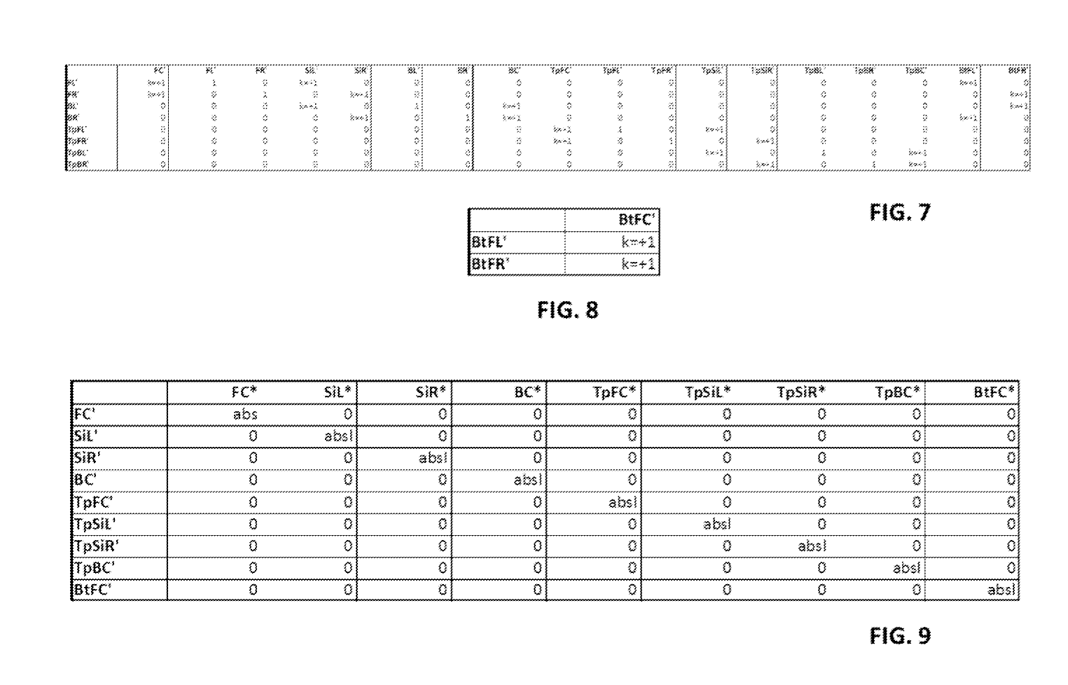

The example of a non-linear inverse coding, here on the basis of the downmix matrix represented in FIG. 2, is constituted with the above preliminary observations by the matrices of FIG. 7 until FIG. 12 to be executed successively in numerically ascending sequence. These matrices are to be read in analogy to the downmix matrix represented in FIG. 2 and explained above, bearing in mind the above-mentioned designations Iᵢ(lⱼ) resp. Iᵢ(1), “k=+1”, “absl” as well as Iᵢ(lⱼ)*.

FIG. 7 illustrates the extraction by means of the comparative correlation of FL′ and FR′, resulting in FC′, of FL′ and BL′, resulting in SiL′, of FR′ and BR′, resulting in SiR′, of BL′ and BR′, resulting in BC′, of TpFL′ and TpFR′, resulting in TpFC′, of TpFL′ and TpBL′, resulting in TpSiL′, of TpFR′ and TpBR′, resulting in TpSiR′, of TpBL′ and TpBR′, resulting in TpBC′, of FL′ and BR′, resulting in BtFL′, and finally of FR′ and BL′, resulting in BtFR′.

FIG. 8 illustrates the comparative correlation between BtFL′ and BtFR′, resulting in BtFC′.

FC′, SiL′, SiR′, BC′, TpFC′, TpSiL′, TpSiR′, TpBC′, BtFC′ are then normalized in FIG. 9 to the known levels of the original signal of the same name.

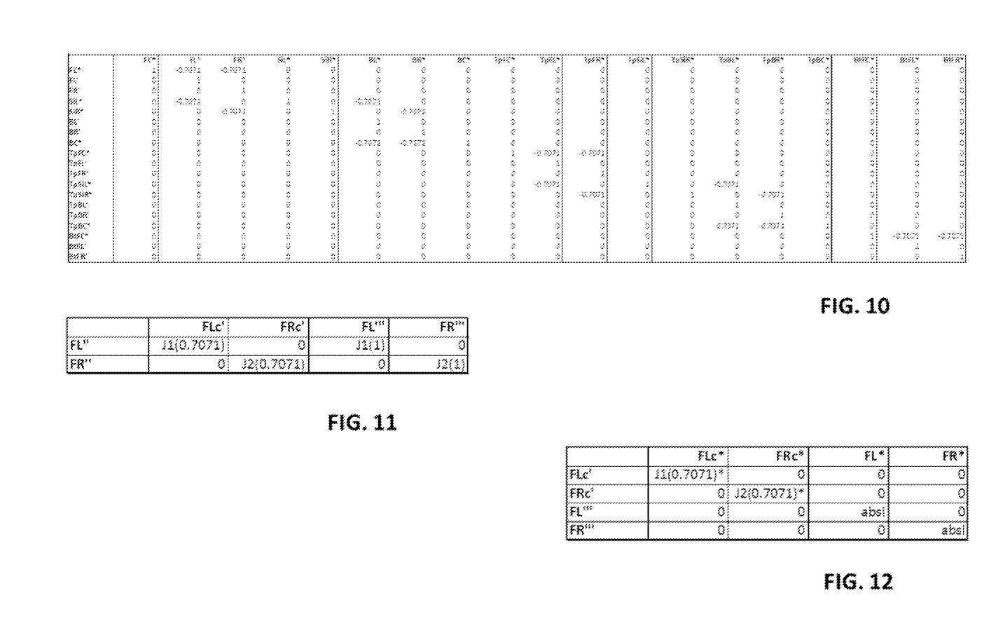

These normalized signals FC*, SiL*, SiR*, BC*, TpFC*, TpSiL*, TpSiR*, TpBC*, BtFC* are in turn subtracted with the level again reduced by −3 dB of the respective neighboring signals of the same layer, thus resulting according to FIG. 10 in FL″, FR″, BL*, BR*, TpFL*, TpFR*, TpBL*, TpBR*, BtFL* and BtFR*.

FIG. 11 in turn illustrates the non-linear inverse coding of FL″, thus resulting in FL′″ and FLc′. FLc′ appears amplified by means of a gain by the factor 0.7071. A non-linear inverse coding of FR″ also takes place, resulting in FR′″ and FRc′. FRc′ also appears amplified by means of a gain by the factor 0.7071.

In FIG. 12, finally, FL′″ and FR′″ are normalized to the known levels of the original signals of the same name, thus resulting finally in FL* and FR*. The channels FLc′ and FRc′ are then equalized to the signals FL* and FR* thus normalized, so that all level characteristics of the non-linear inverse coding are maintained (thus the gains remain effective for the channels respectively with the factor 0.7071 in relation to the current level of these channels), thus resulting finally in FLc* and FRc*.

The means resp. methodologies used for this non-linear inverse coding in turn comprise:
summing of signals,
application of level corrections for respectively summed signals,
extraction of signals by means of comparative correlation,
use of level corrections for signals previously available or obtained stepwise,
normalizing of obtained signals on the basis of known levels of signals previously available or obtained stepwise,
obtaining further signals on the basis of the respective subtraction of signals previously available or obtained stepwise, each with or without level corrections,
obtaining signals on the basis of inverse coding,
adaptation of the level of further channels to the level of signals previously available or obtained stepwise,
if applicable, correction of different loudspeaker distances by means of gains and delays (see above),
obtaining further signals from signals previously available or obtained stepwise.

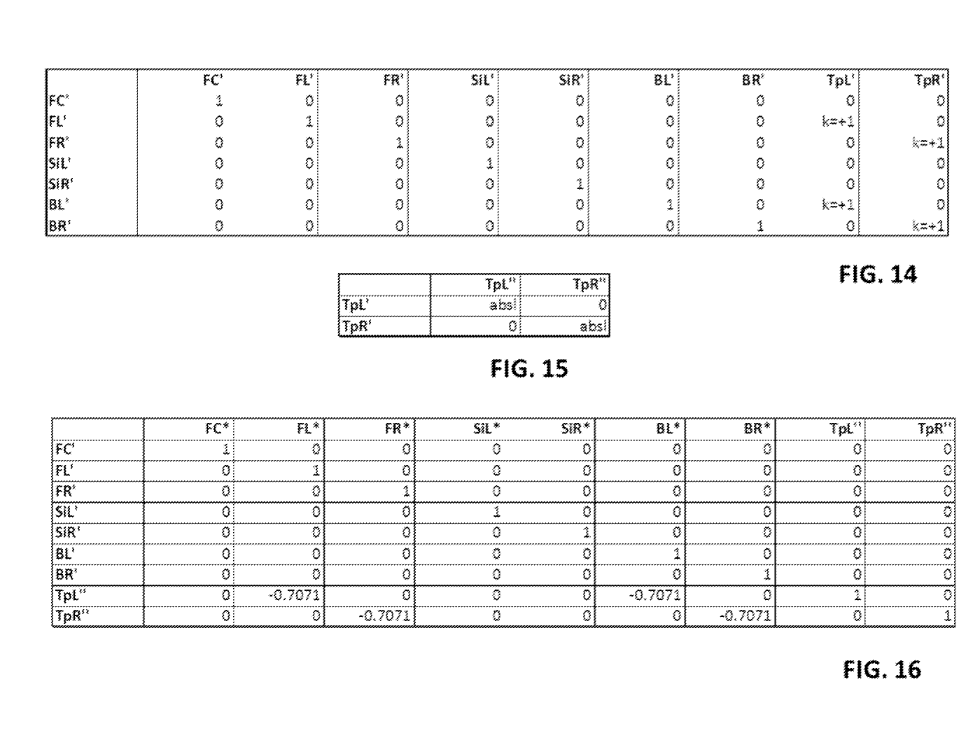

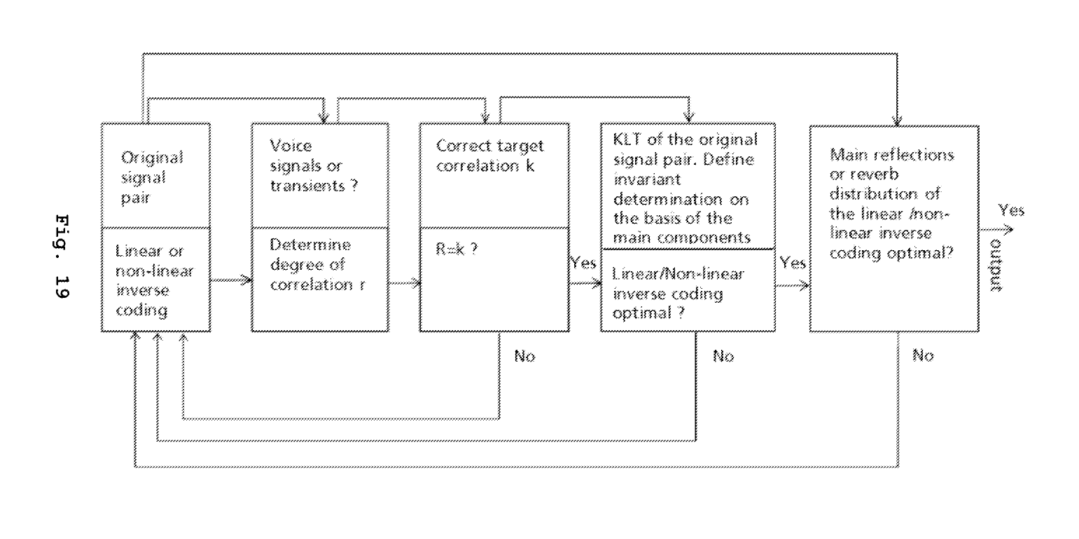

Furthermore, the example of an associated non-linear inverse decoding of a downmix signal according to FIG. 4 can be easily derived from FIG. 5 and FIG. 6 for the above example of a three-dimensional system 12.1 (which represents a subset of the Hamasaki 22.2 system), wherein again with the above preliminary observations the matrices of FIG. 14 until FIG. 18 are to be executed successively in numerically ascending sequence. The matrices are to be read in analogous manner to the downmix matrix represented in FIG. 4 and explained above, this again involving the designations mentioned above Iᵢ(lⱼ) resp. Iᵢ(1), “k=+1”, “absl” as well as Iᵢ(lⱼ).

FIG. 14 represents the approximate extraction of the above-mentioned sum TpL′ of TpFL, TpBL and TpC by means of comparative correlation of FL′ and BL′ and likewise the approximate extraction of the above-mentioned sum TpR′ of TpFR, TpBR and TpC by means of comparative correlation of FR′ and BR′.

According to FIG. 15, TpL′ is then normalized to the initial level of the sum of TpFL, TpBL and TpC and yields TpL“. Likewise, TpR′ is also normalized to the initial level of the sum of TpFR, TpBR and TpC and yields TpR”.

In FIG. 16, TpL″ is then subtracted respectively from FL′ and BL′ with a level decreased by −3 dB, which in this way then results in FL* and BL*. Similarly, TpR″ is subtracted respectively from FR′ and BR′ with a level decreased by −3 dB, which in this way then results in FR* and BR*.

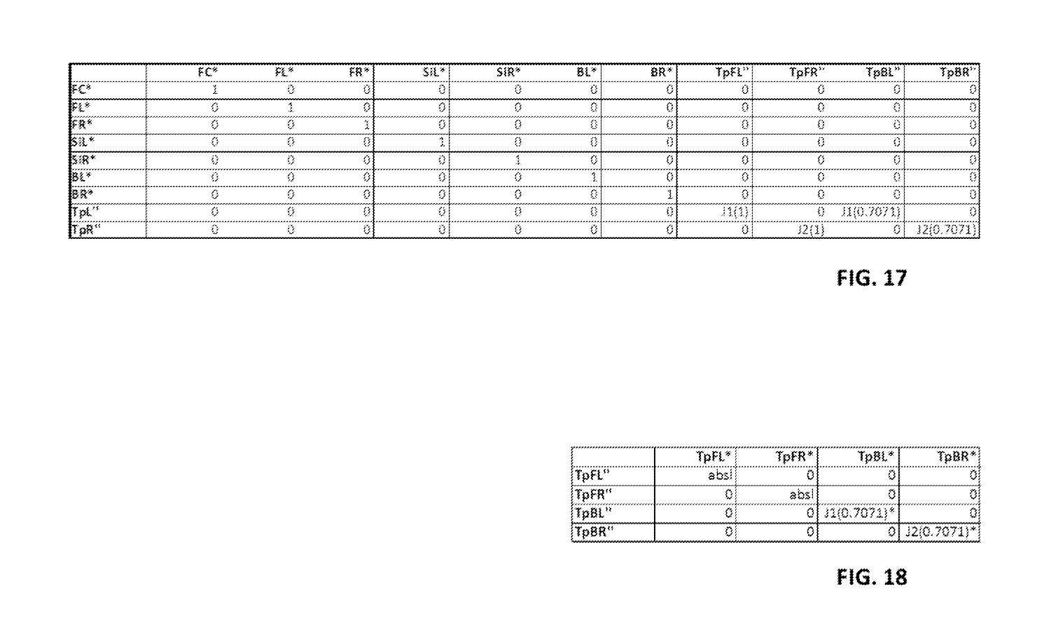

FIG. 17 now illustrates the non-linear inverse coding of TpL″, which results in TpFL″ and TpBL″. TpBL″ appears amplified by means of a gain by the factor 0.7071. Similarly, a non-linear inverse coding of TpR″ takes place, which results in TpFR″ and TpBR″. TpBR″ also appears amplified by means of a gain by the factor 0.7071.

Finally, in FIG. 18 TpFL″ and TpFR″ are normalized to the known levels of the original signals of the same name, thus resulting in TpFL* and TpFR*. The channels TpBL″ and TpBR″ are then equalized to the signals TpFL* and TpFR* thus normalized, so that all level characteristics of the non-linear inverse coding are maintained (thus the gains remain effective for the channels respectively with the factor 0.7071 in relation to the current level of these channels), thus resulting finally in TpBL* and TpBR*.

In particular, the principles of a fictitious TpC described above are again applied.

The means resp. methodologies associated with this non-linear inverse coding in turn comprise:
summing of signals,
application of level corrections for respectively summed signals,
extraction of signals by means of comparative correlation,
use of level corrections for signals previously available or obtained stepwise,
normalizing of obtained signals on the basis of known levels of signals previously available or obtained stepwise,
obtaining further signals on the basis of the respective subtraction of signals previously available or obtained stepwise, each with or without level corrections,
obtaining signals on the basis of inverse coding,
adaptation of the level of further channels to the level of signals previously available or obtained stepwise,
if applicable, correction of different loudspeaker distances by means of gains and delays (see above),
obtaining further signals from signals previously available or obtained stepwise.

### Approximation of Existing Multi-Channel Signals by Means of Linear or Non-Linear Inverse Decoding

It is obvious, starting from a linear or non-linear inverse decoding, to determine its parameters in such a way that an approximation as high as possible of the resulting signal to the initial multi-channel signal is achieved.

Such signal approximations on the basis of linear inverse coding have already been addressed exhaustively in the documents EP1850629, WO2009138205, WO2011009649, WO2011009650, WO2012016992 and WO2012032178 cited by way of reference.

Hereinafter, for all approximations or optimizations described, for the case of an approximation or optimization on the basis of a non-linear inverse coding, it will be tacitly assumed that besides the known parameters of the associated linear inverse coding, the gains (50001, 60001, 60002) of FIG. 5 and FIG. 6 can be involved in this approximation or optimization. Thus, for example, in FIG. 1B of WO2012016992 respectively in L and R a gain (60001 and 60002) each according to FIG. 6 of the present application is to be specified and instead of “new φ or f or α or β”, rather “new φ or f or α or β or l₁ or l₂” is to be specified.

In a first step, the automatic or adaptive downmix or also a technical combination that comprises both elements of an adaptive as well as elements of an automatic downmix, is defined and, according to this downmix or this technical combination, those signals are formed that represent the input signals of the respective non-linear inverse coding.

In a second step, the degree of correlation r of the original signal pair, which subsequently is to be approximated via non-linear inverse coding, is determined on the basis of the short-term cross-correlation. Reference is made in this connection to WO2011009649, page 12 (line 7) until page 13 (line 10), as well as to WO2011009650, page 17 (line 16) until page 19 (line 8).

Inasmuch as these are discrete signals, this degree of correlation r can be negative or lie in the region of 0. In the case of an inverse coding, which starts from a single-channel input signal, this would result in a signal that, although it is strongly de-correlated, for transient, voice or vocal recordings would simultaneously result in strong artifacts.

It is therefore expedient, in a third step, to thus correct the target correlation k represented in WO2011009650 (for example FIG. 1) upwards so that artifacts are avoided as much as possible.

Such a correction depends on the kind of signal. By way of reference value for the artifact-free linear inverse coding for example of language or vocal performances, one must assume k≧+0.66, for the artifact-free linear inverse coding for example of music or noise with strong transients k≧+0.40 and for the artifact-free linear inverse coding for example of music or noise without strong transients k≧0.00.

The technical assessment as to which category an audio signal that is to be inversely coded belongs is part of the state of the art and will therefore not be dealt with any further. As a rule, it will be sufficient to detect the human voice as well as strong transients and for values of the respective degree of correlation r below said lower threshold to specify precisely this lower threshold for the target correlation k.

Thus, in linear inverse coding for example for a vocal signal with the degree of correlation r=+0.45, the associated target correlation is specified with said lower threshold k=+0.66, for a signal with transients having the degree of correlation r=+0.15, the associated target correlation is specified with said lower threshold k=0.40, and for any other signal with the degree of correlation r=−0.15 the associated target correlation is specified with said lower threshold k=0.00.

If the degree of correlation r of a signal with a specific nature is above the lower threshold that would be expedient for it, on the other hand, k=r applies for the target correlation.

Said lower thresholds apply as mentioned in particular for linear inverse coding. In non-linear inverse coding, in the case of signals for example of the order 7 (for example surround 7.1, inasmuch as the LFE channel is not included) or higher, said lower thresholds for the specific signal types can also be lowered by a value between −0.10 to −0.15, without said mentioned artifacts occurring in the end.

The linear or non-linear inversely coded signal is then optimized in such a manner that its degree of correlation r determined on the basis of the short-time cross-correlation matches the specified target correlation k. Reference is again made to WO2011009649, page 12 (line 7) until page 13 (line 10), as well as to WO2011009650, page 17 (line 16) until page 19 (line 8).

In an optional fourth step, the position of the phantom sources for the original signal pair resp. for the linear or non-linear inversely coded signal to be optimized is determined for example using the state-of-the-art Karhunen-Loéve transformation (KLT) or Principal Component Analysis (PCA)—or also its algebraic invariants according to EP1850629, WO2009138205, WO2011009649, WO2011009650, WO2012016992 and WO2012032178. A combination of the just mentioned methods is also possible.

In this manner, it is possible to first perform a Karhunen-Loéve transformation (KLT) for example on a signal section of for example 40 ms of the original signal pair, on the basis of which then as mentioned in WO2012016992 on page 4 (line 22) until page 5 (line 2) the combination ƒ̂(t) or several combinations ƒ₁̂(t), ƒ₂̂(t), . . . , ƒₚ̂(t) of at least two signals s₁(t), n s₁(t), s₂(t), . . . , sₘ(t) resp. of their transfer functions t₁(s₁(t)), t₂(s₂(t)), . . . , tₘ(sₘ(t))—or also the freely definable function ƒ#(t) or the freely definable functions ƒ₁#(t), ƒ₂#(t), . . . , ƒ_{μ}#(t) of one signal s#(t) or several signals s₁#(t), s₂#(t), . . . , s_{Ω}#(t)—considered on the complex number plane resp. their projection on the relief defined by the norm of all points of the complex number plane (the standard cone whose tip lies in the origin of the complex number plane and whose axis of symmetry is perpendicular to the complex number plane)—is for example multi-defined in such a way and subsequently considered in parallel to one another such, that one of the main components of the Karhunen-Loéve transformation respectively represents a subset of the plane described in WO2012016992 on page 7 (lines 17 to 22) resp. on page 10 (lines 11 to 20).

Subsequently, the algebraic invariants of the original signal pair resp. of the linear or non-linear inversely coded signal to be optimized are then determined according to WO2012016992, page 10 (line 21) until page 12 (line 3) and for example optimized according to the figures for WO2012016992, described extensively from page 19 (line 1) until page 78 (line 15).

In WO2012016992 (FIG. 1B, FIG. 3A, FIG. 4A, FIG. 5A, FIG. 6A, FIG. 7A, FIG. 7B, FIG. 8A) it is optionally possible respectively to insert immediately in L or R a gain according to FIG. 5 or FIG. 6 of the present application and thus immediately optimize the already non-linear inversely coded signal.

The considered original signal pair resp. the linear or non-linear inversely coded signal to be optimized can be considered resp. optimized in an optional fifth step in respect of the main reflections as well as the reverb diffusion. To this effect, a signal section of 40 ms is generally sufficient in order to keep the latency of the entire coding correspondingly low and yet record all essential parameters.

From page 28 (line 14) until page 36 (line 8) in WO2012032178, the technical implementation of such a spatial optimization is described, which corresponds to an ideal equivalent of said fifth step.

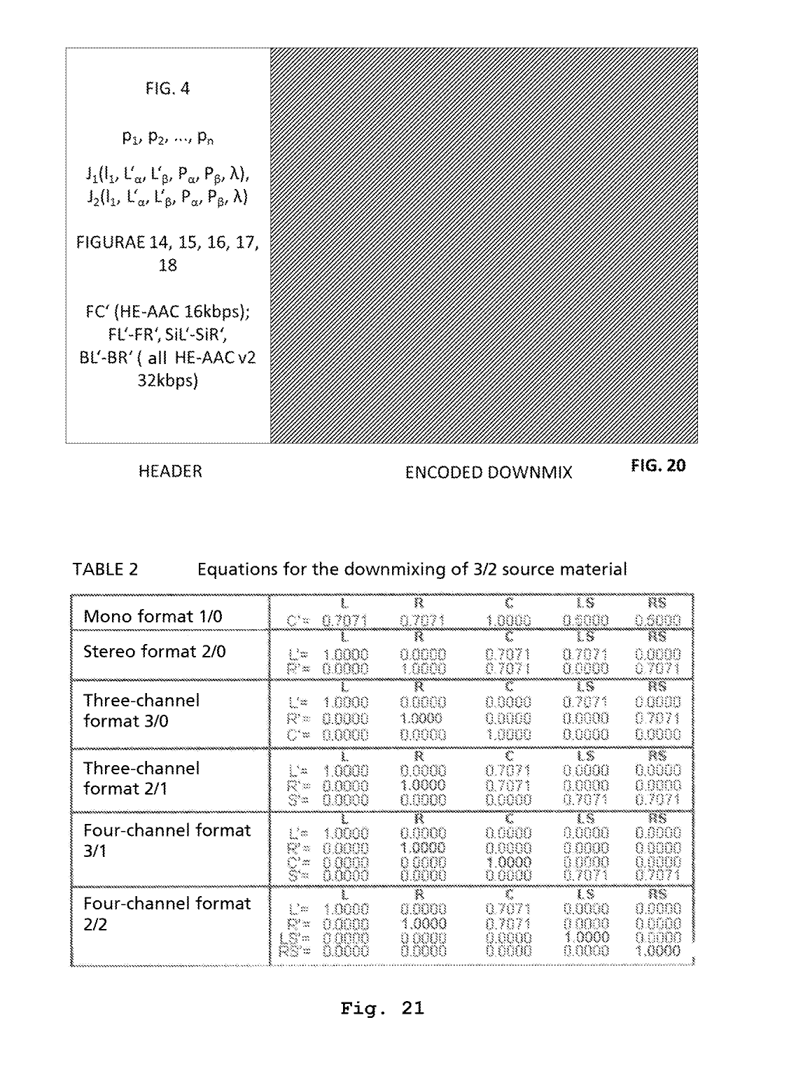

A block schema of said optimization step is shown in FIG. 19.

All mentioned steps can be performed in a modified sequence or fully or partly in other combined partial steps—or can also be fully or partly omitted as such.

Beside the just mentioned optimization, one or several of the optimizations mentioned in EP1850629 or WO2009138205 or WO2011009649 or WO2011009650 or WO2012016992 or WO2012032178 can be used additionally or alternatively.

For the optimization of the previously linear inversely coded signal (so that its degree of correlation r determined on the basis of the short-time cross-correlation matches the specified target correlation k), it is thus possible for example to advantageously include as additional component of the third step the algorithm, described in WO2012032178 from page 25 (line 5) until page 28 (line 13), for weighting the fictitious opening angles α and β for a previously specified target correlation k. Only the appropriate weight p is then to be determined before the fourth and fifth step are executed.

In an alternative, simplified technical solution, the same algorithm simultaneously replaces entirely the fourth and fifth step. In practice, it is thus possible in the case of a concluding non-linear inverse coding whilst maintaining the parameters of the linear inverse coding to already achieve exceptional results with such a configuration.

Interestingly, the optimization therefore supplies on the basis of a linear inverse coding completely first-class results, provided during the subsequent non-linear inverse coding the parameters of the linear inverse coding are maintained whilst a gain (50001) according to FIG. 5 or gains (60001, 60002) according to FIG. 6 are added. This can be attributed to the fact that, when the number of channels increases, the human ear assesses transparency less in terms of the absolute position of the phantom sources but rather in terms of the energy density of the sound field, and in particular in the case of an increasing number of reproduction channels, the immediate psychoacoustic location of the loudspeakers, i.e. nearly point-shaped sound sources, predominates by comparison with the perception of phantom sources between the loudspeakers, on which a modified choice of the parameters of the inverse coding, which defines rather the absolute position of the phantom sources on the stereo base between two loudspeakers, itself no longer exerts any essential influence.

This fact constitutes a clear simplification of the entire system, since the linear inverse coding has in particular the advantage over a non-linear inverse coding of a homogenous stereo base, which significantly simplifies optimization—in particular in terms of the degree of correlation, location of the phantom sources and main reflections as well as reverb distribution.

Parameters of Non-Linear Inverse Coding of a Multi-Channel Signal with or without Base Audio Coder

From the automatic or adaptive downmix or from a technical combination containing both elements of an adaptive as well as elements of an automatic downmix, as well as from the approximation of existing multi-channel signals by means of linear or non-linear inverse coding described above, it is possible to derive a significantly reduced data format—as far as the bandwidth of the original multi channel signal is concerned—for just this multi-channel signal that, in addition to the downmix—possibly compressed with Base Audio Coders—can in particular contain the following information:
structure of the downmix matrix (for example FIG. 4),
absolute level of the original signals as well as signals generated stepwise in the downmix (for example in FIG. 20 indicated with p₁, p₂, . . . , pₙ);
form and parameter of the respectively used inverse codings (for example all gains and delays according to FIG. 5, which can vary with each inverse coding J₁, J₂),
structure of the decoder and form of decoding (for example FIG. 14, FIG. 15, FIG. 16. FIG. 17, FIG. 18);
possibly type of the Base Audio Coders used (for example in FIG. 20 HE-AAC and HE-AAC v2), the form of encoding as well as each of the respective bitrates.

It is easy to understand that these data, which in optimized presentation exhibit exceptionally low bitrates, unlike the permanent Spatial Bitrates known from the state of the art and which can only be used as header information or (for increased security) can also be saved or transferred as data. The amplification factors, level and/or other parameters for the non-linear inverse coding can be transmitted once for each signal section (for example every second). (The permanent transmission, for example related to a sample or a frame or its section is, though impractical, of course also possible, especially if the level of the output channels of an inverse coding should change over the course of time, due to the use of an adaptive downmix for example.)

The concrete example of such a possible data format is shown in FIG. 20.

Loudness Correction of a Multi-Channel Signal Obtained by Means of Non-Linear Inverse Coding with or without Base Audio Coder and Dynamic Range Control (DRC)

It is indeed desirable to increase or decrease the levels of the output channels of a multi-channel signal obtained by means of non-linear inverse coding, by a uniform value, in order to create the same subjective impression of level of loudness as with the original multi-channel signal prior to the non-linear inverse coding. This increase or decrease of the overall level can be achieved by means of the absolute levels of the original signals or signals generated stepwise in the downmix or on the basis of measurements or calculations of the subjectively perceived auditory level (“loudness”), for example on the basis of methodologies described in ITU-R BS.1770-3:2012. Such an increase or decrease can be applied constantly over the course of time or be adapted over the course of time in a continuous or non-continuous manner.

This increase or decrease of the overall level can in particular take into account the characteristics of a Base Audio Coder, which can exert considerable influence on the subjective impression of the auditory level of a multi-channel signal.

Likewise, the methodology of a so-called Dynamic Range Control (DRC) can be applied to a multi-channel signal, using a myriad of aspects to influence the level modulation of a multi-channel, so that the listener perceives an optimized result.

Derivation of any Signals of Higher or Lower Order from a Multi-Channel Signal

Following the above explanations, it is easy to see that a higher level signal with any position of loudspeakers can be derived from any multi-channel signal, since non-existing channels can be derived on the basis of existing or obtained loudspeaker signals for example by means of a linear or non-linear inverse coding.

It is equally easy to see that a lower-order signal with any position of loudspeakers can be obtained from any multi-channel signal, since existing channels by means of an automatic or adaptive downmix—or of a technical combination that contains both elements of an adaptive as well as elements of an automatic downmix—can be reduced, and for determining the respective levels of previously available or obtained stepwise signals, the attenuation characteristic of a panoramic potentiometer from the state of the art can be used. It is also possible to use a linear or non-linear inverse coding for the optimization of the respective generated phantom sound sources and the energy density of the sound field.

In summary, the following can be stated: “Inverse coding” and in particular, “linear inverse coding” describes a technical process that generates spatial audio signals through the specific application of gains and delays that are functionally interdependent. In particular, such an “inverse coding” or “linear inverse coding” can comprise a summation element, an MS-Matrix and one gain connected downstream of this summation element or two potentiometers connected downstream of the MS matrix.

A “non-linear inverse coding” is characterized by the superficially inappropriate additional downstream connecting of at least one gain (50001) in the left or also the right output channel of a configuration for “inverse coding” or “linear inverse coding”.

The invention is not restricted to the embodiment described but all embodiments within the scope of protection of the invention form part of the invention.

Instead of the non-linear inverse coding in the upmix device in claim 31, it is also possible alternatively to use linear inverse coding or other methods of pseudo-stereophony.

An amplification, in the sense of the claim, can mean an amplification factor either greater or smaller than 1, i.e. an amplification according to the invention may also mean an attenuation.

Two signals based on a multi-channel signal can both be two direct channels of the multi-channel signal or one (or both) of the two signals can be based on the combination of two channels of the multi-channel signal. The same is true for signals based on a downmix signal.

The term coding encompasses both the term encoding as well ad decoding.

The term upmix describes the formation of a higher number of channels from a lower number of channels.

The term downmix describes the formation of a lower number of channels from a higher number of channels.

What is claimed is:

1. Upmix or coding device for an audio signal, comprising:
an inverse coding device for determining a first channel and a second channel of the audio signal through linear inverse coding from an input signal;
a first gain connected downstream to the inverse coding device in the first channel for multiplying the first channel with a first factor; or
a first gain connected downstream of the inverse coding device in the first channel for multiplying the first channel with a first factor and a second gain connected downstream of the inverse coding device in the second channel for multiplying the second channel with a second factor, that is different from the first factor,
wherein the upmix or coding device is designed for producing or further processing the first channel multiplied with the first factor without combination with the second channel, and/or for producing or further processing the second channel multiplied with the second factor without combination with the first channel.

2. (canceled)

3. Upmix or coding device according to claim 1, wherein the first factor in the first gain and/or the second factor in the second gain is/are chosen depending on at least one parameter of a downmix that was used for generating the input channel.

4. Upmix or coding device according to claim 1, having an optimization device designed for adjusting the value of the first factor in the first gain and/or of the second factor in the second gain depending on the first channel and/or the second channel.

5. Upmix or coding device according to claim 1, wherein the first factor in the first gain and/or the second factor in the second gain is/are permanently set.

6. Upmix or coding device according to claim 5, wherein the value of the first gain corresponds to 0.5 or 1/\sqrt{2}.

7. Upmix or coding device according to claim 1, having a level correcting device connected downstream of the inverse coding device and the first gain in the first channel and the second channel, designed for adjusting the levels of the first channel and of the second channel depending on at least one parameter of a downmix that was used for generating the input signal or depending on a received level.

8. Upmix or coding device according to claim 3, wherein the input signal is generated from two signals that are based on a multi-channel signal by means of weighted addition and the at least one parameter of the downmix corresponds to the weighting of the two signals.

9. Upmix or coding device according to claim 1, having a receiver device for receiving the input signal and a first value and/or second value, wherein the first factor in the first gain is adjusted according to the received first value and/or the second factor in the second gain is adjusted according to the received second value.

10. Upmix or coding device according to claim 1, wherein the inverse coding device is designed for determining the first channel and the second channel on the basis of parameters received with the input signal.

11. Upmix or coding device according to claim 1, wherein the inverse coding device is designed for determining at least one factor of at least one gain of the inverse coding device and at least one delay of the inverse coding device on the basis of an angle between a sound source and a main axis of a microphone, a virtual left opening angle, a virtual right opening angle and a directional characteristic for the input signal, and for determining a first intermediate signal and a second intermediate signal on the basis of the at least one delay and of the at least one factor of the at least one gain of the inverse coding device, and for determining the first channel and the second channel on the basis of the first intermediate signal and of the second intermediate signal.

12. Upmix or coding device according to claim 11, wherein the inverse coding device is designed for generating, on the basis of at least one weighting factor, the first channel and the second channel, each by means of the weighted addition and/or weighted subtraction of the first and second intermediate signal.

13. Upmix or coding device according to claim 11, wherein the inverse coding device is designed for determining two delays on the basis of the angle between the sound source and the main axis of the microphone, of the left opening angle, of the right opening angle and of the directional characteristic, and for correcting these two delays through a common time factor.

14. Upmix or coding device according to claim 11, wherein the angle between the sound source and the main axis of the microphone, the left opening angle, the right opening angle and/or the directional characteristic are constant.

15. Upmix or coding device according to claim 1, having an optimization device for determining a suitable value for the first factor in the first gain and/or for the second factor in the second gain and/or for parameters of the linear inverse coding.

16. Upmix or coding device according to claim 15, wherein the optimization device is designed for determining the degree of correlation of the first channel and the second channel or of two signals underlying a downmix which was used for the creation of the input signal, and for determining the value of the first factor in the first gain and/or the second factor in the second gain and/or the parameters of the linear inverse coding depending on the degree of correlation.

17. Upmix or coding device according to claim 16, wherein the optimization device is designed for determining the value of the first factor in the first gain and/or the second factor in the second gain and/or the parameters of the linear inverse coding depending on a target degree of correlation.

18. Upmix or coding device according to claim 19, wherein the optimization device is designed to determine the target degree of correlation on the basis of the nature of the first channel and the second channel or of the two signals underlying the downmix.

19. Upmix or coding device according to claim 18, wherein the target correlation
for voice or vocal recordings is greater than or equal to plus zero-point-five-one, in particular greater than or equal to plus zero-point-six-six, and/or
for transients, is greater than or equal to plus zero-point-two-five, in particular greater than or equal to plus zero-point-four, and/or
in the case of other signals, is greater than or equal to minus zero-point-one-five, in particular greater than or equal to zero.

20. Upmix or coding device according to claim 15, wherein the optimization device contains a comparison device for the comparison of the first channel and the second channel with the two signals underlying the downmix in order to determine a suitable value for the first factor in the first gain and/or for the second factor in the second gain and/or for parameters of the linear inverse coding.

21-27. (canceled)

28. Coding device for an audio signal, comprising:
a down-mixer for generating a downmix signal by means of the weighted addition of two signals based on a multichannel signal,
an optimization device designed for determining a suitable value for a first factor of a first gain of an upmix or coding device and/or for a second factor of a second gain, wherein the upmix or coding device comprises:
an inverse coding device for reconstructing the two signals through linear inverse coding of a channel of the downmix signal;
the first gain connected downstream to the inverse coding device in the first channel for multiplying the first channel with the first factor; or
the first gain connected downstream of the inverse coding device in the first channel for multiplying the first channel with the first factor and the second gain connected downstream of the inverse coding device in the second channel for multiplying the second channel with the second factor, that is different from the first factor.

29. Coding device according to claim 28, wherein the optimization device contains the upmix or coding device for the reconstruction of the two signals from the downmix signal to determine the suitable value.

30. Coding device according to claim 28, wherein the optimization device is designed to optimize the weighting of the two signals for the downmix signal.

31. Storage means having a downmix signal with a downmix channel and a value for a first factor in a first gain and/or for a value for a second factor in a second gain for an upmix or coding device, wherein the upmix or coding device comprises:
an inverse coding device for reconstructing two signals underlying one of the at least one downmix channel through linear inverse coding of the one of the at least one downmix channel;
the first gain connected downstream to the inverse coding device in the first channel for multiplying the first channel with the first factor; or
the first gain connected downstream of the inverse coding device in the first channel for multiplying the first channel with the first factor and the second gain connected downstream of the inverse coding device in the second channel for multiplying the second channel with the second factor, that is different from the first factor.

32. Storage means according to claim 31, further comprising levels of channels of the multi-channel signal or levels of channels of the downmix signal.

33-34. (canceled)

35. Method for upmixing or coding an audio signal, having the steps of:
determining a first channel and a second channel of the audio signal through linear inverse coding from an input signal;
multiplication of the first channel with a first factor; or
multiplication of the first channel with a first factor and of the second channel with a second factor, which is different from the first factor
wherein the first channel multiplied with the first factor is not combined with the second channel after this multiplication, and/or the second channel multiplied with the second factor is not combined with the first channel after this multiplication.

36. Method according to claim 35 comprising the further steps:
generating a downmix channel by means of weighted addition of two signals, which are based on a multi-channel,
determining a suitable value for the first factor and/or the second factor.

37. Non-transitory computer program designed, when run on a processor, for executing the steps of:
determining a first channel and a second channel of the audio signal through linear inverse coding from an input signal;
multiplication of the first channel with a first factor; or
multiplication of the first channel with a first factor and of the second channel with a second factor, which is different from the first factor
wherein the first channel multiplied with the first factor is not combined with the second channel after this multiplication, and/or the second channel multiplied with the second factor is not combined with the first channel after this multiplication.

38-42. (canceled)
